(19) United States
(12) Patent Application Publication
(10) Pub. No.: US 2007/0088747 A1
(43) Pub. Date: Apr. 19, 2007

(54) AUTOMATIC MULTIMEDIA SEARCHING METHOD AND MULTIMEDIA DOWNLOADING SYSTEM THEREOF

(76) Inventors: Chih-Chuan Cheng, Taipei City (TW); Tsai-Chuang Wang, Taipei City (TW); Chun-Ying Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,796

(22) Filed: Feb. 22, 2006

(30) Foreign Application Priority Data
Oct. 19, 2005 (TW) 94136519

(51) Int. Cl. G06F 17/00

(52) U.S. Cl. 707/104.1

(57) ABSTRACT

An automatic multimedia searching method and the multimedia downloading system thereof are provided, which are capable of increasing user's convenience on multimedia searching and downloading events. The method includes the following steps. First, an electronic device which stores a multimedia file and a data source connection are provided. Next, a multimedia file is played. When playing the multimedia file, the electronic device automatically searches the data source for multimedia files having the same content as the content of the information tag in the multimedia file. Finally, the found multimedia files are displayed on the electronic device.

### CROSS-REFERENCE TO RELATED APPLICATION

This application claims the priority benefit of Taiwan application serial no. 94136519, filed on Oct. 19, 2005. All disclosure of the Taiwan application is incorporated herein by reference.

### BACKGROUND OF THE INVENTION

1. Field of the Invention

The present invention relates to a method for automatically searching multimedia files and the downloading system thereof. More particularly, the present invention relates to a method for downloading multimedia files by using a middle server to automatically compare the information tag and the system thereof.

2. Description of Related Art

The conventional method for downloading multimedia files from the network is generally through connection between the computer and the network, the user has to manually search and download the required multimedia information. Various electronic devices are usually operated during the process of obtaining the required multimedia information, which may cause inconvenience to those unfamiliar with either the electronic device interface or the network usage interface. For example, the operations of searching and downloading may be difficult to children or elders.

In the conventional technology, an electronic device does not provide the functions of automatically searching and downloading multimedia files through the network according to the user's requirement besides the operation functions. Generally, the searching, downloading and updating of the multimedia data in the electronic device have to be done manually. Moreover, the electronic device cannot automatically provide the user with up-to-date multimedia information for the user to select the required multimedia file directly.

### SUMMARY OF THE INVENTION

Accordingly, the present invention is directed to provide a method for automatically searching multimedia file, which can search and download related multimedia information directly from the network by comparing the contents of the information tags provided by the electronic device and the network, so as to increase the user's convenience on searching and downloading multimedia file.

According to another aspect of the present invention, a system for automatically downloading multimedia file is provided, which compares the content of the information tag provided by the electronic device using a middle server, so that the electronic device can search and download related multimedia information from the network directly, and the user's convenience on searching and downloading multimedia file is increased.

To achieve the aforementioned and other objectives, the present invention provides a method for automatically searching multimedia file, which includes the following steps of providing an electronic device storing multimedia files and having capability of connecting to a data source; playing the multimedia file according to the user's selection; wherein when playing the multimedia file, the electronic device automatically connects to the data source according to the content of the information tag in the multimedia file to search for multimedia files having the same content as the content of the information tag, and wherein the data source can be a storage medium, e.g. website, flash drive, or storage media for storing multimedia files; and displaying the found multimedia files on the electronic device for the user to select, and automatically downloading the selected multimedia file from the data source into the electronic device.

In an embodiment, the step of searching for multimedia files having the same content as the content of the information tag described above includes the following steps of providing a middle server; transferring the information tag to the middle server, wherein the middle server searches for multimedia files having the same content as the content of the information tag on the network; and sending the list of the found multimedia files to the electronic device. After the foregoing steps, the electronic device displays the list of the found multimedia files for the user for selection, and the electronic device downloads the selected file from the data source into the electronic device.

In an embodiment, the aforementioned information tag is an identification information of a multimedia file, the content thereof includes at least one of the followings: a name of the multimedia file, a player, playing duration and an IP address. Moreover, if the multimedia file is a MP3 music file, the information tag thereof is an ID3 tag. If the multimedia file is a video file, the information tag thereof is a video tag.

According to another aspect of the present invention, a system for automatically downloading multimedia files is provided, which includes an electronic device, a multimedia server and a middle server. The electronic device is used for playing the multimedia file, and has the capability of connecting to the network. The multimedia server is used for providing downloadable multimedia files. The middle server is connected to the electronic device and at least one multimedia server. Wherein, when playing the multimedia file, the electronic device automatically transfers the content of the information tag in the multimedia file to the middle server. The middle server searches in the multimedia server for files having the same content as the content of the information tag and transfers the list of the found files back to the electronic device. When one file is selected from the list of the found files, the electronic device notifies the middle server to download the corresponding multimedia content from the multimedia server.

In an embodiment, the aforementioned information tag is the identification information of a multimedia information, the content thereof includes at least one of followings: a name of the multimedia file, a player, a playing duration, and at least one of the IP addresses. Moreover, if the multimedia file is a MP3 music file, the information tag thereof is an ID3 tag. If the multimedia file is a video file, the information tag thereof is a video tag.

According to an exemplary embodiment of the present invention, since the information tag is used as the identification of a multimedia file, and the contents of the information tag provided by the electronic device and the network are compared by the middle server to directly search and download related multimedia information and files from the network into the electronic device without going through the steps of downloading and transferring files through personal computers. Thus, the present invention provides a greater convenience in searching and downloading multimedia files into the electronic device is increased.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a system for automatically downloading multimedia files according to an embodiment of the present invention.

FIG. 2 is a flowchart illustrating a method for automatically searching for multimedia files according to an embodiment of the present invention.

FIG. 3A is a diagram illustrating an operation interface for automatically downloading multimedia files according to an embodiment of the present invention.

FIG. 3B is a diagram illustrating an operation interface for automatically downloading multimedia files.

FIG. 3C is a diagram illustrating a list of multimedia files to be automatically downloaded.

### DESCRIPTION OF EMBODIMENTS

Referring to FIG. 1, which is a schematic block diagram illustrating a system for automatically downloading multimedia files according to an embodiment of the present invention. The system comprises an electronic device 110, a middle server 120 and multimedia servers 130, 140, 150, and 160. The electronic device 110 is a multimedia playing device, e.g. CD player, MP3 player, cell phone etc., used for playing multimedia files. The electronic device has the capability of connecting to the network and storing multimedia files having information tags. The middle server 120 is connected to the electronic device 110 and the multimedia servers 130, 140, 150, and 160 respectively. The data source 190 refers to all storage media including multimedia servers 130, 140, 150, and 160, flash drive, website etc., and there are multimedia files stored in the data source 190. The multimedia files stored in the data source also have information tags used for determining the related information of the multimedia files. Wherein, when playing a multimedia file, the electronic device 110 transfers the content of the information tag in the multimedia file to the middle server 120. The middle server 120 automatically searches in the data source 190 for multimedia files having the same content as the content of the information tag based on the information tag and transfers the list of the found multimedia files back to the electronic device 110 to be displayed on the electronic device 110. When the user selects one file from the list of the found files, the electronic device 110 notifies the middle server 120 to download the corresponding multimedia file from the multimedia servers 130, 140, 150, and 160 into the electronic device 110.

The multimedia servers 130, 140, 150, and 160 refer to websites or servers storing multimedia files and multimedia file data source, the names or number of the data sources connected to the electronic device 110 or the middle server 120 is not limited. In the present embodiment, the foregoing information tag is the identification information of multimedia information, which includes the name of the multimedia file, the player, the playing duration, or the IP addresses. Moreover, if the multimedia file is a MP3 music file, the information tag thereof is an ID3 tag. If the multimedia file is a video file, the information tag thereof is a video tag.

In the present embodiment, besides the functions of automatically comparing and downloading multimedia file, the aforementioned middle server 120 also has the functions of setting up a content provider and providing a plurality of connections to the data source 190 (including website, multimedia servers 130, 140, 150, and 160 etc.). Pre-sold points are provided as the method of payment for the file download service, for example, pre-sold points payment method provided for on-line games. When the user uses the electronic device to download multimedia files through the middle server 120, the middle server 120 identifies the user through, e.g. password identification, and charges the user by deducting points directly. The user can browse the required multimedia information directly or set up a particular network address to browse the particular multimedia information on the electronic device 110 and downloads the required multimedia file directly without going through any additional payment procedure. Thus, the present invention provides greater convenience to both the users and the service providers, and effectively reduces the transaction cost.

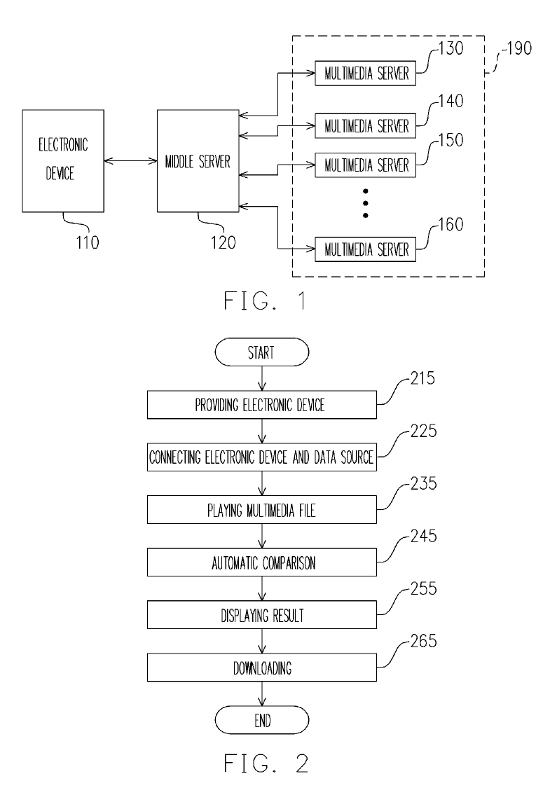

FIG. 2 is a flowchart illustrating a method for automatically searching for multimedia files according to an embodiment of the present invention, and the flow starts from step 215. The system components shown in FIG. 1 will be referred here for better understanding of the present invention by those skilled in the art. First, at step 215, an electronic device 110 is provided, which may be a multimedia playing device or a multimedia file storage device, e.g. CD player, MP3 player, cell phone etc., and the electronic device 110 stores multimedia files having information tags. In the present embodiment, the aforementioned information tag is identification information of the multimedia information, the content thereof includes the name of multimedia file, the player, the playing duration, or the IP addresses. Moreover, if the multimedia file is a MP3 music file, the information tag thereof is an ID3 tag. If the multimedia file is a video file, the information tag thereof is a video tag.

Next, at step 225, the electronic device 110 is connected to the data source 190 through the middle server 120. The data source 190 may be storage media including multimedia servers 130, 140, 150, and 160, flash drive, website, etc., and the data source 190 stores multimedia files having information tags. The information tags may be used for determining the related information of the multimedia files. Next, at step 235, the multimedia files in the electronic device 110 or in the data source 190 are provided for the user to browse, and the multimedia file required by the user is played. After that, at step 245, when playing the multimedia file, the electronic device 110 transfers the content of the information tag in the multimedia file to the middle server 120. The middle server 120 searches on the network for multimedia files having the same content as the content of the information tag of the multimedia file and the middle server 120 transfers the list of the found multimedia files back to the electronic device 110. When the electronic device 110 receives the list of multimedia files transferred back by the middle server 120, the flow proceeds to step 255. At step 255, the electronic device 110 displays the list of the multimedia files for the user to browse. At step 265, the multimedia file selected by the user is automatically downloaded and stored into the electronic device 210 for the user to use.

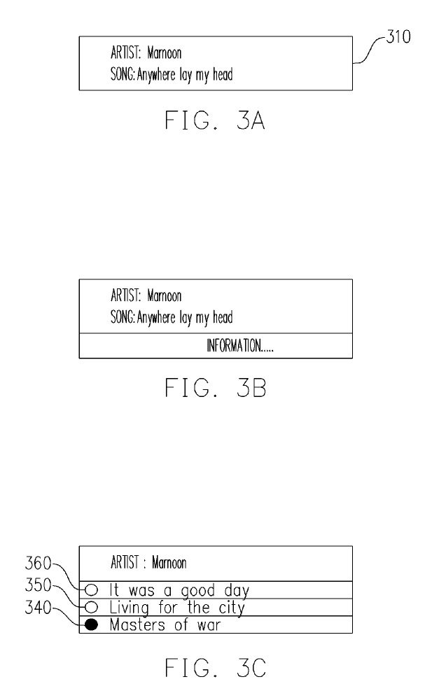

FIG. 3A is a diagram illustrating an operation interface for automatically downloading multimedia files according to an embodiment of the present invention. When the user plays the multimedia file, the electronic device 110 displays the related information, e.g. the player or the name of the player, the title of the music, the duration, of the music selected by the user. The content of the related information of the music is determined based on the related information of various multimedia files, for example, the director, the name of the actor, playing progress etc., and will not be described here. Next, the electronic device 110 automatically compares the content of the information tag of the music shown in the display menu 310 on the network and transfers back the list of music titles having the same content as the content of the information tag. During this process, the electronic device 110 displays a message of “data in processing”, as shown in FIG. 3B. After the transfer is finished, the electronic device 110 displays the list of the obtained multimedia files, as shown in FIG. 3C. In the present embodiment, a list of the other songs' by the singer Marnoon is displayed, and the titles of the songs are listed and provided with option tags 340, 350, and 360 for the user to select the item to be download. The user can select directly, as the option tag 340. After the user has selected an option tag, the selected multimedia file is downloaded automatically, e.g. the music file with title “Master of war” in the present embodiment.

According to an exemplary embodiment of the present invention, since the information tag is used for automatically identifying and searching for multimedia file, and the contents of the information tags provided by the electronic device and the network are compared by the middle server to automatically download related multimedia information and files from the network without going through the steps of searching for the multimedia file manually, the user's convenience in searching and downloading multimedia files into the electronic device is increased.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for automatically searching multimedia files, comprising:
providing an electronic device having capability of connecting to a data source, wherein the electronic device is adopted for storing a multimedia file having a information tag;
playing the multimedia file;
the device automatically searching the data source for finding multimedia files having a same content as a content of the information tag in the multimedia file when playing the multimedia file; and
displaying found multimedia files on the electronic device.

2. The method as claimed in claim 1, further comprising:
selecting one of the found multimedia files; and
downloading the selected multimedia file from the data source.

3. The method as claimed in claim 1, wherein the multimedia file is a MP3 music file, and the information tag is ID3 tag.

4. The method as claimed in claim 1, wherein the multimedia file is a video file, and the information tag is a video tag.

5. The method as claimed in claim 1, wherein the content of the information tag includes at least one of the following: a name of the multimedia file, a player, a playing duration, and an IP address.

6. The method as claimed in claim 1, wherein the data source is a website.

7. The method as claimed in claim 1, wherein the data source is a storage medium.

8. A system for automatically downloading multimedia files, comprising:
an electronic device, used for playing a multimedia file, having the capability of connecting to a network;
a multimedia server, providing downloadable multimedia files; and
a middle server, connected to the electronic device and the multimedia server, wherein, when playing the multimedia file, the electronic device automatically transfers a content of an information tag in the multimedia file to the middle server, the middle server searches the multimedia server for multimedia files having a same content as the content of the information tag, and the middle server transfers a list of found files back to the electronic device.

9. The system as claimed in claim 8, wherein the multimedia file is a MP3 music file, and the information tag is ID3 tag.

10. The system as claimed in claim 8, wherein the multimedia file is a video file, and the information tag is a video tag.

11. The system as claimed in claim 8, wherein the content of the information tag includes at least one of the followings: a name of the multimedia file, a player, a playing duration and an IP address.
